(19) United States
(12) Patent Application Publication
(10) Pub. No.: US 2024/0153348 A1
(43) Pub. Date: May 9, 2024

(54) LOTTERY TICKETS BASED ON PRODUCT PURCHASES THROUGH SYSTEMS SUCH AS POINT-OF-SALE SYSTEMS

(71) Applicant: IGT Global Solutions Corporation, Providence, RI (US)

(72) Inventors: Joseph Charest, Attleboro, MA (US); Sarah Walker, Warwick, RI (US)

(21) Appl. No.: 18/053,163

(22) Filed: Nov. 7, 2022

(51) Int. Cl. G07F 17/32; G06Q 20/20; G06Q 50/34

(52) U.S. Cl. CPC G07F 17/3255; G06Q 20/209; G06Q 50/34; G07F 17/3211; G07F 17/329

(57) ABSTRACT

Point-of-sale (POS) systems and methods that enable purchase of instant win lottery tickets through the POS systems, wherein each wager amount for each instant win lottery ticket and each award that can be won via each instant win lottery ticket are directly based on the purchase amount of a purchase of one or more goods and/or services by a purchaser on which the instant win lottery ticket is based.

### BACKGROUND

The present disclosure relates to lottery tickets based on product purchases through systems such as point-of-sale (“POS”) systems and that enable purchase of lottery tickets through the system.

Various different types of lottery tickets may be sold to players. For example, instant win lottery tickets and draw lottery tickets may be sold to players. Such lottery tickets may be purchased and redeemed at retail locations.

### BRIEF SUMMARY

In various embodiments, the present disclosure relates to a point-of-sale system including a server, a terminal, and a display device, wherein the server and the terminal are configured to: (1) cause a display, by the display device, of an indication of an option for a purchase of an instant win lottery ticket associated with a purchase of a product by a purchaser for a purchase amount, wherein the product includes at least one of a plurality of different goods or at least one of a plurality of different services; (2) cause a display, by the display device, of an indication of a wager amount for the instant win lottery ticket, the wager amount being directly based on the purchase amount for the purchase of the product by the purchaser; and (3) cause a display, by the display device, of an indication of an award that can be won from the instant win lottery ticket, wherein the award is also directly based on the purchase amount for the purchase of the product by the purchaser. In various such embodiments, the probability of winning is a static probability of winning regardless of the purchase amount and regardless of the wager amount.

In various other embodiments, the present disclosure relates to a point-of-sale system including a server, a terminal, and a display device, wherein the server and the terminal are configured to: (1) cause a display, by the display device, of an indication of a first option for a purchaser to pay for a purchase amount for a product, wherein the product includes at least one of a plurality of different goods or at least one of a plurality of different services; (2) cause a display, by the display device, of an indication of a second option including a wager amount for the purchaser to purchase an instant win lottery ticket associated with the purchase of the product, and an indication of the wager amount, wherein the wager amount is directly based on the purchase amount for the purchase of the product by the purchaser; (3) cause a display, by the display device, of an indication of an award won from the instant win lottery ticket, wherein the award is directly based on the purchase amount for the purchase of the product by the purchaser. In various such embodiments, the probability of winning is a static probability of winning regardless of the purchase amount and regardless of the wager amount.

In various other embodiments, the present disclosure relates to a point-of-sale system including a server, a terminal, and a display device, wherein the server and the terminal are configured to: (1) cause a display, by the display device, of an indication of a first option for a purchaser to pay for a purchase amount for a product, wherein the product includes at least one of a plurality of different goods or at least one of a plurality of different services; (2) cause a display, by the display device, of an indication of a second option including a wager amount for the purchaser to purchase an instant win lottery ticket associated with the purchase of the product, and an indication of the wager amount, wherein the wager amount is equal to a percentage greater than zero and less than ten percent of the purchase amount for the purchase of the product by the purchaser; (3) cause a display, by the display device, of an indication of a first award that can be won from the instant win lottery ticket, wherein the first award is equal to the purchase amount for the purchase of the product by the purchaser; and (4) cause a display, by the display device, of an indication of a second award that can be won from the instant win lottery ticket, wherein the second award is equal to a percentage of the purchase amount for the purchase of the product by the purchaser, wherein the percentage is greater than zero and less than one hundred percent. In various such embodiments, the probability of winning is a static probability of winning regardless of the purchase amount and regardless of the wager amount.

Additional features are described in, and will be apparent from, the following Detailed Description and the figures.

### BRIEF DESCRIPTION OF THE SEVERAL VIEWS OF THE DRAWINGS

FIG. 1 is a diagrammatic view of an example POS system that enables purchase of lottery tickets through the POS system, wherein the wager amount for each lottery ticket and each award that can be won from each lottery ticket are directly based on the purchase amount of a purchase of one or more goods and/or services by a purchaser in accordance with the present disclosure.

FIGS. 2A, 2B, 2C, 2D, and 2E are example screen displays that can be displayed by an example POS system that enables purchase of lottery tickets through the POS system, wherein the wager amount for each lottery ticket and each award that can be won from each lottery ticket are directly based on the purchase amount of a purchase of goods and/or services by a purchaser in accordance with the present disclosure.

### DETAILED DESCRIPTION

In various embodiments, the present disclosure relates generally to a system such but not limited to a point-of-sale system (referred to herein as a POS system) and to methods of operating such systems (such as POS systems) that enables purchase of instant win lottery tickets through the systems (such as the POS systems), wherein each wager amount for each lottery ticket and each award that can be won from each lottery ticket are directly based on the purchase amount of a purchase of goods and/or services by a purchaser. For brevity, POS systems are used herein as an example of the systems; however, it should be appreciated that the systems and methods of the present disclosure are not limited to POS systems and methods. Also, for brevity, the goods and/or services are referred to herein as a product or as products. In other words, the term product is meant herein to include at least one good and/or at least one service. The term product and the terms goods and services are meant herein to be products, goods, and services other than lottery tickets and other than other wagering devices or wagering services. In other words, the terms products, goods, and services are meant herein to exclude lottery tickets and other wagering devices or wagering services.

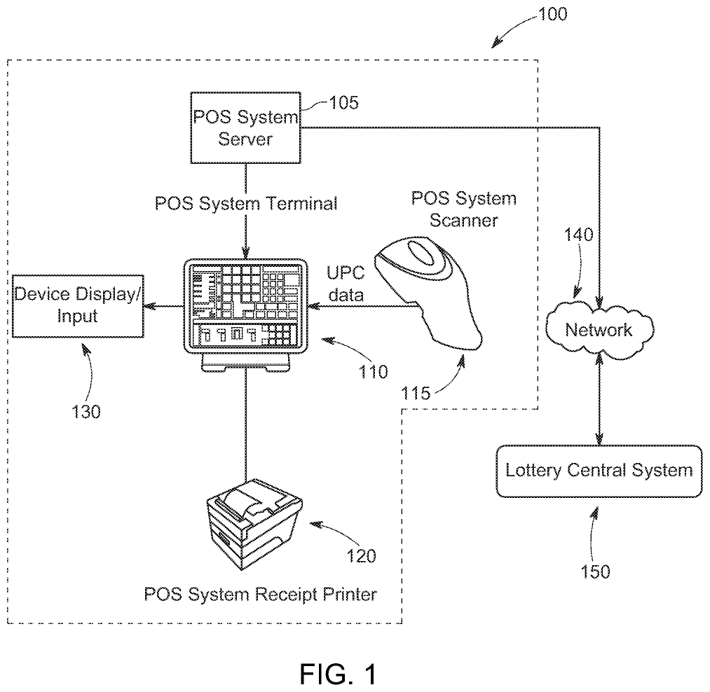

FIG. 1 illustrates a POS system 100 of one example embodiment of the present disclosure. This example POS system 100 includes a POS system server 105, a POS system terminal 110, a POS system scanner 115, a POS system receipt printer 120, and a display/input device 130 in accordance with an example embodiment of the present disclosure. In various embodiments, the POS system can include one or more of each of these components. In various embodiments, each display/input device can be a combined display/input device or can be separate display and input devices. In this example embodiment, the POS system 100 is configured to communicate via a suitable communication network 140 to a lottery central system 150 to enable the purchase of instant win lottery tickets through the POS system 100, wherein the wager amount for each instant win lottery ticket and the potential awards for each instant win lottery ticket are directly based on the purchase amount of a purchase of at least one product by a purchaser via the POS system 100. Since various components of the POS systems are well known, for brevity, a further explanation of such individual components is not provided herein.

In various embodiments, the POS system 100 is employed to provide a purchaser an opportunity to: (1) make a wager via the purchase of a lottery ticket based on the purchase amount for at least one product that the purchaser pays for such product(s), and to (2) win an award that is also based on the purchase amount for such product(s). In various embodiments, the POS system 100 is configured to provide each lottery ticket that is of the instant win type and each wager for each lottery ticket that is of the instant win wager type. In other embodiments, the lottery tickets and the awards can be of other suitable types such as fast play type lottery tickets.

In various embodiments, for each instant win type lottery ticket, the wager (or purchase amount) for such lottery ticket is equal to a predetermined percentage (such as 5%) of the purchase amount for the product(s) that the purchaser pays for such product(s). In various embodiments, the wager amount is equal to a percentage greater than zero and less than ten percent of the purchase amount for the purchase of the product by the purchaser. Thus, it should be appreciated that the instant win wagers for different lottery tickets can substantially vary based on the variances in the different purchase amounts for the different products. In various other embodiments, for each instant win type lottery ticket, the wager (or purchase amount) for such lottery ticket can be within a range determined based on the purchase amount for the product(s) that the purchaser pays for such product(s). In various other embodiments, for each instant win type lottery ticket, the wager (or purchase amount) for such lottery ticket can be a static amount based on the purchase amount for the product(s) that the purchaser pays for such product(s) or ranges of purchase amounts for the products. For example, (1) if the purchase amount is $100-$120, the wager can be $5.00; (2) if the purchase amount is $121 to $140, the wager can be $6.00; and (3) if the purchase amount is $141 to $160, the wager can be $7.00.

In various embodiments, the winnable award is equal to the total purchase amount for the product(s) that the purchaser pays for such product(s). In various other embodiments, the winnable award is equal to a percentage (such as 50%) that is greater than zero percent and less than one hundred percent of the total purchase amount for the product(s). In various other embodiments, the winnable award is equal to: (1) the total purchase amount for the product(s), or (2) a percentage (such as 50%) that is greater than zero percent and less than one hundred percent of the total purchase amount for the product(s). In various other embodiments, the winnable award is equal to either: (1) the total purchase amount for the product(s), or (2) one of a plurality of different percentages (such as 25%, 50%, and 75%) that are each greater than zero percent and less than one hundred percent of the total purchase amount for the product(s). In various other embodiments, the winnable award is either equal to one of a plurality of different percentages (such as 25%, 50%, and 75%) that are each greater than zero percent and less than one hundred percent of the total purchase amount for the product(s). In various other embodiments, for each instant win type lottery ticket, the amount of the award can be a static amount based on the purchase amount for the product(s) that the purchaser pays for such product(s) or ranges of purchase amounts for the products. For example, (1) if the purchase amount is $100-$120, the award can be $90.00; (2) if the purchase amount is $121 to $140, the award can be $110.00; and (3) if the purchase amount is $141 to $160, the award can be $130.00. For any of the above various different embodiments, in further embodiments, the winnable award can additionally include an amount equal to the wager for the instant win lottery ticket.

In various embodiments, for each instant win lottery ticket, there is a predetermined probability that the purchaser will win an award associated with that instant win lottery ticket. For example, the probability of the award for the lottery ticket being either half or the entire purchase amount for the product(s) can be 1 in 16.67 times regardless of the purchase amount. Thus, in various embodiments, the total probability of winning is for one or more of the award are static regardless of the purchase amount for the products and regardless of the wager amount for the instant win lottery ticket. Any suitable other static probabilities can be employed in accordance with the present disclosure. Thus, in various embodiments, the predetermined probability does not vary based on the purchase amounts of either the product(s) or the wager amount. In one such example, (1) the purchase amount for the products is $58.40; (2) the wager amount is $2.92 (which is 5% of $58.40); (3) the static probability of winning of winning an award equal to 100% of $58.40 is 1/100 or 1%; (4) the static probability of winning an award equal to 50% of $58.40 is 1/20 or 5%; and (5) thus the overall static probability of winning is 16.67%. This example shows that the static probability can be based on different awards and different associated static probabilities.

In various other embodiments, the predetermined probability can vary based on the varying purchase amount. In various other embodiments, the predetermined probabilities can vary based on different ranges of purchase amounts.

In various embodiments, the purchaser can take the steps to make any purchase (such as groceries, clothing, a meal) as the purchaser would normally take at a provider of such goods and/or services (such as a retailer, a wholesaler, or any other suitable entity) that has a POS system configured in accordance with the present disclosure.

In various embodiments, the during check-out process, after all of the goods and/or services being purchased by the purchaser are entered into the POS system 100, after the POS system 100 has calculated a total purchase amount for such goods and/or services, after the POS system 100 has received payment for the total purchase amount for such goods and/or services, the POS system 100 determines and displays via the display/input device 140 and to the purchaser an option to purchase the instant win lottery ticket associated with and based on the total purchase amount of the product(s).

In various embodiments, the POS system 100 displays via the display/input device 140 various different information regarding this instant win lottery ticket such as further described below. This displayed information can include but is not limited to: (a) the wager amount for the lottery ticket based on the purchase amount; (b) the potential award(s) based on the purchase amount and the wager amount; and/or (c) the likelihood of winning one or more potential awards.

In various embodiments, the POS system 100 provides the purchaser the options: (a) paying the purchase amount; and (b) paying for the purchase amount and paying for the instant win lottery ticket. In various other embodiments, the POS system 100 provides the purchaser the options: (a) paying the purchase amount; and (b) paying for the instant win lottery ticket (but not yet paying for the purchase amount until the outcome of the lottery ticket is determined). It should be appreciated that these two different embodiments vary in the timing of the payment for the purchase amount. In the first embodiment, the purchase amount is paid before or at the same time the lottery ticket is purchased and thus, any winning amount from the lottery ticket is subsequently provided to the purchaser via an award redemption device (such as via a voucher, receipt, or winning instant lottery ticket) that the purchaser can then subsequently redeem to receive the award from the winning lottery ticket. In the second embodiment, the purchase amount for the product(s) is not paid at the same time the lottery ticket is purchased, and thus any winning award from the lottery ticket can be applied to the payment of the purchase amount for the product(s). In certain versions of the second embodiment, the POS system automatically applies any winning amount to the payment of the purchase amount for the product(s). In other versions of the second embodiment, the POS system enables the purchaser to apply any winning award to the payment of the purchase amount of the product(s).

In various embodiments, the options can be displayed and provided to the purchaser via the display/input device 140 of the POS system 100 (such as, for example, via at a checkout station or on a system electronic mobile device positionable at a purchaser's table at a restaurant). In various embodiments, the options can be displayed and provided to the purchaser in other suitable manners, such as via a player electronic mobile device (via a web site or application). In various embodiments where systems other than POS systems display and provide the options to the purchaser, any suitable electronic device can be employed to display and provide such options and receive the purchaser selection of one of the options.

In various embodiments, if the purchaser decides to pay the purchase amount without purchasing the instant win lottery ticket, the purchase proceeds in a conventional manner and no instant win lottery ticket is purchased or otherwise determined.

In various other embodiments, if the purchaser decides to purchase the instant win lottery ticket, the purchaser payment of the purchase amount proceeds along with the purchaser payment for the instant win lottery ticket. In various embodiments, the POS system 100 obtains from the purchaser the wager amount for the instant win lottery ticket and the purchase amount for the product(s). These payments can be made in any suitable manner in accordance with the present disclosure. In various embodiments, the POS system 100 requires the purchaser to purchase the lottery ticket and purchase the product(s) using a suitable payment method (such via cash, a credit card, a debit card). The payments can be made as a single transaction (such as a single credit card or debit card transactions) or as multiple transactions (such as a multiple credit card or debit card transactions) in accordance with the present disclosure.

In various other embodiments, if the purchaser decides to purchase the instant win lottery ticket, the payment of the purchase amount is delayed for a short period of time until the instant win lottery ticket is purchased from the lottery system and redeemed if the purchased instant win lottery ticket is a winning lottery ticket. In various such alternative embodiments, the POS system 100 obtains from the purchaser the wager amount for the instant win lottery ticket and then subsequently the payment for the purchase amount as necessary.

As mentioned above, in various embodiments, the purchase amount for the instant win lottery ticket is a based on a static percentage of the purchase amount (regardless of the purchase amount) for the product(s). In various other embodiments, this purchase amount for the instant win lottery ticket is based on a variable percentage based on the purchase amount for the product(s).

In various embodiments, the POS system 100 communicates, via the network 140, with the lottery central system 150, to facilitate the purchase of the instant win lottery ticket. The lottery central system 150 also determines: (1) if the instant win lottery ticket is a winning lottery ticket; and (2) if so, the award associated with the instant win lottery ticket. In various embodiments, the lottery central system can make these determinations in any suitable manner. In various embodiments, the lottery central system is run by an authorized lottery provider entity such as a governmental lottery entity. In various embodiments, the lottery central system is run by an authorized lottery provider entity that is not a governmental lottery entity but is authorized to do so such as by but not limited to a governmental lottery authority. Thus, a public or private entity can provide the lottery central system 150.

In various embodiments, the lottery central system 150 communicates, via the network, back to the POS system 100 whether the instant win lottery ticket is a winning lottery ticket; and (2) if so, the award associated with the instant win lottery ticket. In various alternative embodiments, the lottery central system 150 provides various predetermined instant win lottery tickets to the POS system 100 for the POS system to employ.

In various embodiments, the POS system 100 then display an indication to the purchaser as to whether the instant win lottery ticket is a winning lottery ticket, and if so, the award associated with that winning instant win lottery ticket.

In various embodiments, if the instant win lottery ticket is not a winning lottery ticket, the POS system 100 requires the purchaser to complete the purchase using a suitable payment method (such via cash, a credit card, or a debit card) for the entire purchase amount. In certain such embodiments, the POS system 100 processes such payment form that it previously received. In various embodiments where the purchaser has already completed the purchase using a suitable payment method for the entire purchase amount, the POS system 100 does not need to process a further payment.

In various embodiments, if the instant win lottery ticket is a winning lottery ticket and the award is equal to the purchase amount, the POS system 100 applies such award to the purchase amount and completes the purchase. In various other embodiments, if the instant win lottery ticket is a winning lottery ticket and the award is equal to the purchase amount, the POS system 100 has already completed the payment by the purchaser of the purchase amount, the POS system 100 creates and provides an award redemption device (such as a voucher, receipt, or winning instant lottery ticket) to the purchaser in the amount of such award for redemption by the purchaser.

It should be appreciated that the lottery ticket or award redemption device can be provided to the purchaser in other suitable manners in accordance with the present disclosure. For example, the lottery ticket can be provided to the player in a form that the player can play a game or otherwise determine if the lottery ticket is a winning lottery ticket. In various examples, the lottery ticket has a predetermined reveal or other suitable indication that enables the purchaser to determine if the lottery ticket is a winning lottery ticket and if so, the award associated with such winning lottery ticket.

In various embodiments where the purchaser has already paid the purchase amount and the wager amount, if the instant win lottery ticket is a winning lottery ticket, the POS system 100 creates and provides an award redemption device (such as a physical or virtual voucher, receipt, or winning instant lottery ticket) to the purchaser in the amount of such award for redemption by the purchaser. The purchaser can then take such award redemption device to a lottery terminal to redeem such award in a conventional manner. In other embodiments, the system of the present disclosure such as the POS system is configured to enable the redemption of the award redemption device and payment of the award to the purchaser.

In various alternative embodiments where the purchaser has not paid the purchase amount, if the instant win lottery ticket is a winning lottery ticket and the award is equal to or less than (such as half of) the purchase amount, the POS system 100 applies such award to the purchase amount and requires the purchaser to complete payment for the purchase (if necessary) using a suitable payment method (such via cash, a credit card, or a debit card) for any remaining purchase amount. In various such embodiments, the POS system 100 automatically processes a payment form (such as a credit card or a debit card) that it previously received.

In various embodiments, such as where allowed by law, any tips, service charges, shipping charges, handling, or other fees, and/or sales taxes (or the like) can be included in the purchase amount, and thus do not need to be separately paid for by the purchaser but processed as part of the total purchase amount as indicated above.

In various other embodiments, such as where not allowed by law, any tips, service charges, shipping charges, handling, or other fees, and/or sales taxes (or the like) can be excluded from the purchase amount, and thus needs to be separately paid for by the purchaser. In such cases, the POS system 100 requires the purchaser to complete the payment of such amount(s) using a suitable payment method (such via cash, a credit card, or a debit card).

In various embodiments, the POS system 100 is configured to enable an operator of the POS system to make one or more inputs (such as via a suitable display/input device 140) to cause the POS system to determine the instant win lottery ticket wager amount and to make such offer to the purchaser. In various other embodiments, this is done for each purchase via the POS system. In various other embodiments, this is done for randomly selected purchases via the POS system. In various other embodiments, this is done for purchases via the POS system that are at least a predetermined minimum amount. In various other embodiments, this is done for purchases via the POS system where the purchase amounts are at least a certain minimum amount. In various other embodiments, this is done for purchases via the POS system where the purchase amounts are at most a predetermined maximum amount. In various other embodiments, this is done for purchases via the POS system where the purchase amounts are at least a certain minimum amount and are at most a predetermined maximum amount.

In various embodiments, responsive to a purchaser purchasing an instant win lottery ticket, the POS system 100 creates in real time an instant win lottery ticket request (or the instant win lottery ticket request data) based on and including data representing the purchase amount for the product(s). The POS system 100 transmits via the data network 140 in real time the instant win lottery ticket request (or instant win lottery ticket request data) to the lottery central system 150. In various embodiments, the lottery central system 150 receives and processes the instant win lottery ticket request (or instant win lottery ticket request data) for the instant win lottery ticket. In various embodiments, the lottery central system 150 creates in real time the instant win lottery ticket and randomly determines if the instant win lottery ticket is a winning lottery ticket and if so the amount of the win. This can be done in any suitable manner such as but not limited to conventional manners for determining if an instant win lottery ticket is a winning ticket and if so, the amount thereof. In various embodiments, based on such determination(s) for the instant win lottery ticket, the lottery central system 150 creates in real time a winning instant lottery ticket voucher (or the winning instant lottery ticket voucher data) based on the purchase amount. The lottery central system 150 transmits via the data network 140 in real time the winning instant lottery ticket voucher (or winning instant lottery ticket voucher data) to the POS system 100. In various embodiments, the POS system 100 receives and processes the winning instant lottery ticket voucher (or winning instant lottery ticket voucher data) for the winning instant lottery ticket. In various embodiments, the POS system 100 prints, such as via the POS system receipt printer, the winning instant lottery ticket voucher (or other award redemption device) based on the received winning instant win lottery ticket voucher (or winning instant lottery ticket voucher data). In various other embodiments, the POS system 100 prints, such as via the POS system receipt printer 120, the received winning instant lottery ticket voucher for the purchaser to subsequently redeem. In various embodiments, the POS system 100 can print and provide a receipt printed by the POS system receipt printer 120 for the winning instant lottery ticket. In various embodiments, the receipt can be part the receipt for the purchase or a separate receipt. In various other embodiments, the purchaser can use the printed winning instant lottery ticket voucher for the purchase amount or part thereof. In various such embodiments, the POS system scanner 115 can be used to scan and process the printed winning instant lottery ticket voucher and apply the award as a credit.

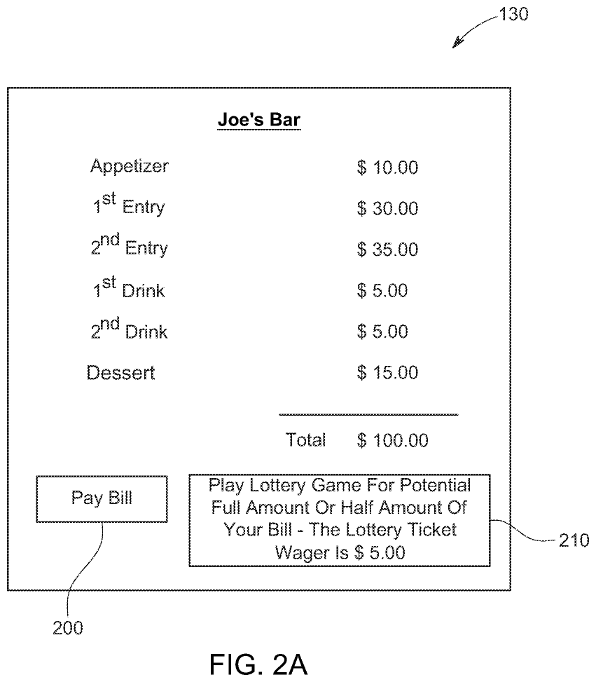

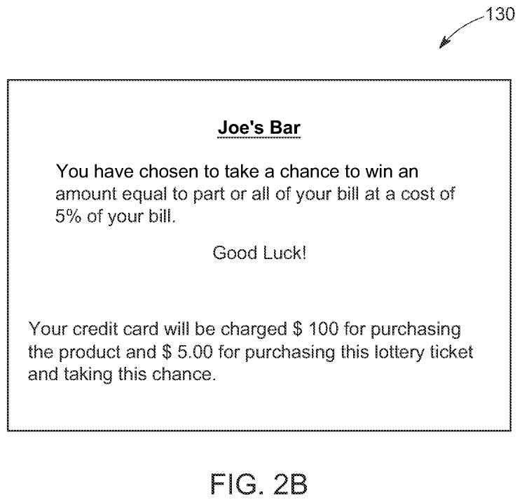

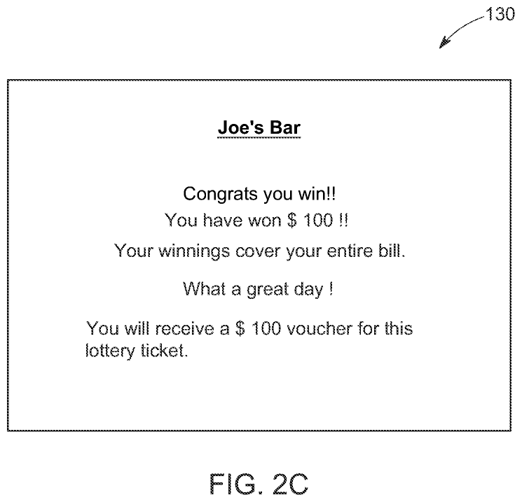

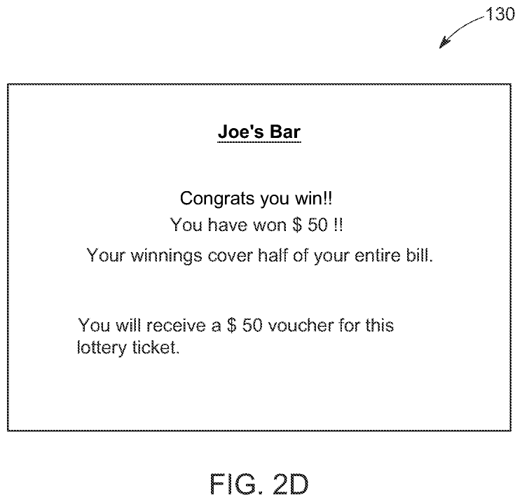

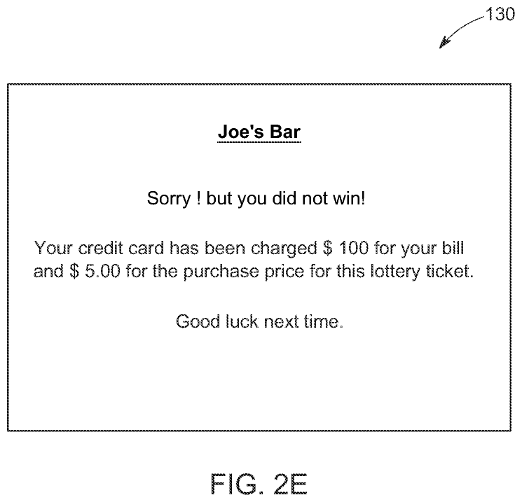

FIGS. 2A, 2B, 2C, 2D, and 2E illustrate example screen displays displayed by an example POS system that enables purchase of a lottery ticket through a POS system in accordance with an example embodiment of the present disclosure. FIGS. 2A, 2B, 2C, 2D, and 2E show example displays by a display/input device 130 of a POS system 100 at a restaurant called Joe's Bar. In this example, for ease of explanation, the POS system 100 process the payment for the purchase amount before receiving the determination from the lottery central system 150 of whether the instant win lottery ticket is a winning lottery ticket and if so the amount of the award. As explained above, in other embodiments, the POS system 100 processes the payment for the purchase amount after sending a request for the instant win lottery ticket to the lottery central system 150 and after the determination by the lottery central system 150 of whether the instant win lottery ticket is a winning lottery ticket and if so the amount of the award.

The FIG. 2A screen displays a plurality of items ordered by a purchaser (which is one of the two people dinning at Joe's Bar in this example) and the respective purchase prices for these items. The FIG. 2A screen displays that the total purchase amount for the six example products is $100.00. This example does not include any tip or taxes for simplicity. Such additional amounts can be addressed such as discussed above. The FIG. 2A screen displays a first indication and first purchaser input 200 labeled “Pay Bill” that is selectable by the purchaser, and when selected, enables the purchaser to pay the purchase amount in a conventional manner. The FIG. 2A screen displays a second indication and second purchaser input 210 labeled “Play Lottery Game for Potential Full Amount or Half Amount of Your Bill—The Lottery Ticket Wager is $5.00” that is alternatively selectable by the purchaser, and when selected causes the purchase of the instant win lottery ticket such as described above. In this example embodiment, the POS system 100 process the payment for the purchase amount at this point in time; however, in other example embodiments, the POS system 100 does not yet process the payment for the purchase amount at this point in time.

The FIG. 2B screen displays an indication of a confirmation to the purchaser that the purchaser has selected the second purchaser input 210 and to purchase the instant win lottery ticket. The FIG. 2B screen also displays an indication that the purchaser's credit card is charged $100 for the purchase amount for the products and the $5.00 purchase amount for purchase of the instant win lottery ticket. Again, in this example embodiment, the POS system 100 processes the payment for the purchase amount at this point in time; however, in other example embodiments, the POS system 100 does not yet process the payment for the purchase amount at this point in time.

The FIG. 2C screen displays an indication that the purchased lottery ticket is a winning lottery ticket and that the amount won is $100. The FIG. 2C screen displays an indication that the amount won of $100 will cover the entire purchase amount. The FIG. 2C screen also displays a further indication that the purchaser will receive a $100 voucher for the winning instant win lottery ticket. In various example embodiments, the voucher is a document printed by the POS system receipt printer 120. This voucher can be redeemed by the purchaser such as at a lottery system terminal or other suitable redemption system. In this example embodiment where the POS system 100 has already processed the payment for the purchase amount, the POS system 100 thus provides any winning amount from the lottery ticket to the purchaser via an award redemption device (such as via a voucher, receipt, or winning instant lottery ticket) at this point in time. In other example embodiments, the POS system 100 processes the payment for the purchase amount at this point in time.

The FIG. 2D screen displays an alternative outcome that includes an indication that the purchased lottery ticket is a winning lottery ticket and that the amount won is $50. The FIG. 2D screen displays an indication that the amount won of $50 is equal to half of the purchase amount. The FIG. 2D screen also displays a further indication that the purchaser will receive a $50 voucher for the winning instant win lottery ticket. In various example embodiments, the voucher is a document printed by the POS system receipt printer 120. This voucher can be redeemed by the purchaser such as at a lottery system terminal or other suitable redemption system. In this example embodiment where the POS system 100 has already processed the payment for the purchase amount, the POS system 100 thus provides any winning amount from the lottery ticket to the purchaser via an award redemption device (such as via a voucher, receipt, or winning instant lottery ticket) at this point in time.

The FIG. 2E screen displays a further alternative outcome that includes an indication that the purchased lottery ticket is not a winning lottery ticket. The FIG. 2E screen also displays a further indication that the purchaser's credit card has been charged the $100 for the purchase amount for the products and $5.00 for the purchase of instant win lottery ticket. In the other example embodiments where the POS system 100 has not already processed the payment for the purchase amount, the POS system 100 processes any further payments.

In various other embodiments, the present disclosure provides a system such but not limited to an online POS system and to methods of operating such online POS systems for online purchases of products. The online POS system enables the purchase of instant win lottery tickets through the online POS system, wherein each the wager amount for each lottery ticket and each award that can be won from each lottery ticket are directly based on the purchase amount of a purchase of products by a purchaser. The online POS system can function in substantially the same manners as described above, except that the purchaser can function as the operator as necessary, and except that any printing of an award redemption device (such as a voucher, receipt, or winning instant lottery ticket) would be via a printer of the purchaser. Such online POS systems can alternatively provide such award redemptions in other suitable manners such as for example via credits available at one or more online stores or currency handling systems.

In various embodiments, the purchaser can function as an operator of the POS system where the POS system is configured for self-check-out by the purchaser. In various such embodiments, certain of the actions described above that are taken by the operator would be taken by the purchaser to effectuate the purchase of the instant win lottery ticket. Such actions can include the scanning actions and the receipt of payment actions (such as via a credit or debit card) as described above.

These various example embodiments of the present disclosure provide a series of advantages that enable lottery tickets to be purchased and redeemed via systems such as POS systems. The advantages include but are not limited to the following advantages: (a) providing a relatively low cost and inobtrusive manner for providing lottery tickets that can be purchased during a checkout process in a wholesaler facility, a retailer facility, or other facility that enables the POS system therein to be used for the purchase and redemption of lottery tickets; (b) not requiring substantial changes to how operators use such devices or collect payments from purchasers; (c) providing such devices with limited required additional training by operators in such facilities to use such devices; (d) maintaining security needs for lottery systems and/or the providers' own network(s); and (e) generating POS receipts that function as redemption devices for lottery tickets.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

1. A point-of-sale system comprising:
a server;
a terminal; and
a display device, wherein the server and the terminal are configured to:
cause a display, by the display device, of an indication of an option for a purchase of an instant win lottery ticket associated with a purchase of a product by a purchaser for a purchase amount, wherein the product comprises at least one of a plurality of different goods or at least one of a plurality of different services,
cause a display, by the display device, of an indication of a wager amount for the instant win lottery ticket, the wager amount being directly based on the purchase amount for the purchase of the product by the purchaser, and
cause a display, by the display device, of an indication of an award that can be won from the instant win lottery ticket, wherein the award is also directly based on the purchase amount for the purchase of the product by the purchaser.

2. The point-of-sale system of claim 1, wherein the server and the terminal are configured to cause a display, by the display device, of an indication that the award was not won by the purchaser.

3. The point-of-sale system of claim 1, wherein the server and the terminal are configured to cause a display, by the display device, of an indication that the award was won by the purchaser.

4. The point-of-sale system of claim 3, wherein the server and the terminal are configured to cause a display of an indication of the award won by the purchaser on an award redemption device separate from the display device.

5. The point-of-sale system of claim 4, which comprises a printer configured to print the award redemption device.

6. The point-of-sale system of claim 3, wherein the server and the terminal are configured to cause a display, by the display device, of an indication that the award won by the purchaser was automatically provided to the purchaser.

7. The point-of-sale system of claim 1, wherein the award is equal to the purchase amount.

8. The point-of-sale system of claim 1, wherein the server and the terminal are configured to cause a display, by the display device, of an indication of a plurality of different awards can be won from the instant win lottery ticket, wherein each of the plurality of different awards is directly based on the purchase amount for the purchase of the product by the purchaser.

9. The point-of-sale system of claim 8, wherein the plurality of awards comprise a first award equal to the purchase amount and a second award equal to half of the purchase amount.

10. The point-of-sale system of claim 1, wherein the wager amount is equal to a percentage of the purchase amount.

11. The point-of-sale system of claim 1, wherein the server and the terminal are configured to cause a display, by the display device, of an indication of an option for the purchaser to pay for the product without the purchase of the instant win lottery ticket simultaneously with the display of the option for the purchase of the instant win lottery ticket associated with the purchase of the product.

12. A point-of-sale system comprising:
a server;
a terminal; and
a display device, wherein the server and the terminal are configured to:
cause a display, by the display device, of an indication of a first option for a purchaser to pay for a purchase amount for a product, wherein the product comprises at least one of a plurality of different goods or at least one of a plurality of different services,
cause a display, by the display device, of an indication of a second option comprising a wager amount for the purchaser to purchase an instant win lottery ticket associated with the purchase of the product, and an indication of the wager amount, wherein the wager amount is directly based on the purchase amount for the purchase of the product by the purchaser, and
cause a display, by the display device, of an indication of an award won from the instant win lottery ticket, wherein the award is directly based on the purchase amount for the purchase of the product by the purchaser.

13. The point-of-sale system of claim 12, wherein the award is equal to the purchase amount.

14. The point-of-sale system of claim 12, wherein the server and the terminal are configured to cause a display, by the display device, of an indication of a plurality of different awards can be won from the instant win lottery ticket, wherein each of the plurality of different awards is directly based on the purchase amount for the purchase of the product by the purchaser, and wherein the displayed award won is one of the plurality of different awards.

15. The point-of-sale system of claim 14, wherein the plurality of awards comprise a first award equal to the purchase amount and a second award equal to half of the purchase amount.

16. The point-of-sale system of claim 12, wherein the wager amount is equal to a percentage of the purchase amount.

17. A point-of-sale system comprising:
a server;
a terminal; and
a display device, wherein the server and the terminal are configured to:
cause a display, by the display device, of an indication of a first option for a purchaser to pay for a purchase amount for a product, wherein the product comprises at least one of a plurality of different goods or at least one of a plurality of different services,
cause a display, by the display device, of an indication of a second option comprising a wager amount for the purchaser to purchase an instant win lottery ticket associated with the purchase of the product, and an indication of the wager amount, wherein the wager amount is equal to a percentage greater than zero and less than ten percent of the purchase amount for the purchase of the product by the purchaser,
cause a display, by the display device, of an indication of a first award that can be won from the instant win lottery ticket, wherein the first award is equal to the purchase amount for the purchase of the product by the purchaser, and
cause a display, by the display device, of an indication of a second award that can be won from the instant win lottery ticket, wherein the second award is equal to a percentage of the purchase amount for the purchase of the product by the purchaser, wherein the percentage is greater than zero and less than one hundred percent.

18. The point-of-sale system of claim 17, wherein the percentage is fifty percent.

19. The point-of-sale system of claim 17, wherein the server and the terminal are configured to cause a display, by the display device, of an indication that the first award or the second award won by the purchaser was automatically provided to the purchaser.

20. The point-of-sale system of claim 17, wherein the server and the terminal are configured to cause a display of an indication of the first award, or the second award won by the purchaser on an award redemption device.
